(19) United States
(12) Patent Application Publication
(10) Pub. No.: US 2018/0345931 A1
(43) Pub. Date: Dec. 6, 2018

(54) ELETRICAL SYSTEM FOR USE IN A VEHICLE

(71) Applicant: Jaguar Land Rover Limited, Whitley (GB)

(72) Inventors: Christopher HARRIES, Whitley (GB); Gary Edwards, Whitley (GB); David Halward-Smith, Whitley (GB)

(21) Appl. No.: 15/991,751

(22) Filed: May 29, 2018

(30) Foreign Application Priority Data
May 31, 2017 (GB) 1708614.1.1

(51) Int. Cl. B60T 8/88; B60T 8/171; B60T 17/22

(52) U.S. Cl. CPC B60T 8/885; B60T 2270/414; B60T 17/221; B60T 8/171

(57) ABSTRACT

The invention relates to an electrical system for use in a vehicle. The electrical system comprises a controller and electrically operable vehicle brake means. The electrical system comprises at least one vehicle electric load including vehicle brake control means operable to selectively control the vehicle brake means to move between an engaged position in which the vehicle brake means acts to inhibit movement of the vehicle and a disengaged position in which the vehicle brake means does not act to inhibit movement of the vehicle. The electrical system also comprises first and second batteries for providing electric power to the vehicle brake means and the at least one vehicle electric load. In response to detection of a fault in the electrical system, the controller is operable to electrically isolate the second battery and the vehicle brake means from the first battery and the at least one vehicle electric load, and the vehicle brake means is configured to automatically assume the engaged position.

### CROSS-REFERENCE TO RELATED APPLICATION

This application claims priority under 35 U.S.C. § 119 to Great Britain Application No. 1708614.1, filed May 31, 2017, the content of which is incorporated herein by reference in its entirety.

### TECHNICAL FIELD

The present disclosure relates to an electrical system and particularly, but not exclusively, to an electrical system for use in a vehicle. Aspects of the invention relate to an electrical system, to a method, and to a vehicle.

### BACKGROUND

It is known to provide a vehicle with different types of brake means for holding the vehicle stationary. Firstly, a hand brake or parking brake is provided to engage the disc or drum brakes of a vehicle. Traditionally, such a parking brake would be operated by the driver actuating a lever in the driver cabin, which would cause cables attached to the brakes to tense up, which in turn would cause the brake pads to squeeze against the drums so as to engage the brakes. In more modern vehicles, the parking brake is operated electrically by means of a push button in the driver cabin so as to cause motors to squeeze the pads onto the drums of the brakes.

Secondly, a transmission or parking pawl may be provided so that, when in an engaged position, it guards against rotation of an output shaft of a vehicle transmission, thereby preventing movement of the vehicle. The pawl may take the form of a pin that engages in a series of notches on the output shaft of the transmission. In a vehicle having an automatic transmission, the transmission pawl may engage automatically when the vehicle is at rest and a park mode of the transmission is selected, utilising hydraulic pressure available from the internal combustion engine. Traditionally, transmission pawls are monostable, meaning that continuous application of hydraulic pressure is needed to keep the transmission pawl engaged.

In electric vehicles without a conventional transmission, there may not be hydraulic pressure available to operate a transmission pawl described above. In some electric vehicles, only an electronic parking brake is provided, meaning that in the case of an electrical failure the vehicle cannot be held stationary other than by application of a driver foot pedal.

It is an aim of the present invention to address disadvantages associated with the prior art.

### SUMMARY OF THE INVENTION

According to an aspect of the present invention there is provided an electrical system for use in a vehicle. The electrical system may comprise a controller and electrically operable vehicle brake means. The electrical system may also comprise at least one vehicle electric load including vehicle brake control means operable to selectively control the vehicle brake means to move between an engaged position in which the vehicle brake means acts to inhibit movement of the vehicle and a disengaged position in which the vehicle brake means does not act to inhibit movement of the vehicle. The electrical system may comprise first and second batteries for providing electric power to the vehicle brake means and the at least one vehicle electric load. In response to detection of a fault in the electrical system, the controller may be operable to electrically isolate the second battery and the vehicle brake means from the first battery and the at least one vehicle electric load, and the vehicle brake means may be configured to automatically assume the engaged position.

The invention is advantageous in that in the event of a complete shutdown or failure of the vehicle electrical systems, in particular electronic vehicle braking systems, the vehicle can still be brought to rest and held stationary until the failure is rectified. Specifically, note that the invention is not limited to a fail-safe in the event of removal or failure of a main battery of the vehicle, but is operable to engage or apply the vehicle brake means in the event of a fault occurring anywhere across the electrical system.

The controller may comprise an electronic processor having an electrical input for receiving an indication that a fault has been detected. The system may comprise an electronic memory device electrically coupled to the electronic processor and having instructions stored therein. The processor may be configured to access the memory device and execute the instructions stored therein such that it is operable to electrically isolate the second battery and the vehicle brake means from the first battery and the at least one vehicle electric load based on the received indication of a fault.

The vehicle brake control means may comprise an electronic processor having an electrical input for receiving a signal indicative of a demanded state of the vehicle brake means. The system may comprise an electronic memory device electrically coupled to the electronic processor and having instructions stored therein. The processor may be configured to access the memory device and execute the instructions stored therein such that it is operable to selectively control the vehicle brake means to move between an engaged position in which the vehicle brake means acts to inhibit movement of the vehicle and a disengaged position in which the vehicle brake means does not act to inhibit movement of the vehicle.

The electrical system may comprise an electronic switch. The electrical system may be operable to change the first switch from a closed position to an open position to electrically isolate the second battery and the vehicle brake means from the first battery and the at least one vehicle electric load.

The fault may be detected with reference to a change in a measured value of the voltage across the electrical system.

The fault may be detected if the change in the measured value of the voltage results in the measured value falling below a predetermined measured voltage value.

The fault may be detected if the measured value falls below the predetermined measured voltage value for at least a predetermined period of time.

The fault may be detected if the first battery is removed from the electrical system.

The fault may be detected if the first battery has substantially zero electric charge. The fault may be detected if a short is detected in the electrical system.

The fault may be detected if a loss of power is detected in at least one of the at least one vehicle electric loads.

In response to detection that the fault in the electrical system has been removed, the controller may be operable to electrically connect the second battery and the vehicle brake means to the first battery and the at least one vehicle electric load, and the vehicle brake means may be configured to remain in the engaged position.

The vehicle brake means may be bistable in the engaged and disengaged positions.

The first battery may be connected in parallel with the second battery.

The first battery may have a greater capacity than the second battery.

The vehicle brake means may comprise engaging means configured to engage with an output shaft of a transmission of the vehicle when the vehicle brake means is in the engaged position so as to inhibit rotation of the output shaft.

The engaging means may comprise a transmission pawl configured to engage a notched wheel of the output shaft when the vehicle brake means is in the engaged position.

The transmission pawl may be configured to ratchet the notched wheel when the vehicle brake means is in the engaged position and a speed of the vehicle is greater than a speed threshold value.

The transmission pawl may be configured to come into locked engagement with the notched wheel when the vehicle brake means is in the engaged position and the speed of the vehicle is less than the speed threshold value.

The vehicle brake control means may be operable by a driver of the vehicle.

The at least one vehicle electric load may comprise further electrically operable vehicle brake means. The vehicle brake control means may be operable to selectively control the further vehicle brake means to move between an engaged position in which the further vehicle brake means acts to inhibit movement of the vehicle and a disengaged position in which the further vehicle brake means does not act to inhibit movement of the vehicle.

The further brake means may be an electric parking brake.

The vehicle brake control means may be configured to command the vehicle brake means and the further vehicle brake means to assume their respective engaged positions when a park mode of the transmission is selected by the driver.

According to another aspect of the invention there is provided a method for use in a vehicle electrical system. The electrical system may comprise a controller, electrically operable vehicle brake means, at least one vehicle electric load including vehicle brake control means operable to selectively control the vehicle brake means to move between an engaged position in which the vehicle brake means acts to inhibit movement of the vehicle and a disengaged position in which the vehicle brake means does not act to inhibit movement of the vehicle, and first and second batteries for providing electric power to the vehicle brake means and the at least one vehicle electric load. The method may comprise detecting a fault in the electrical system, and in response thereto, electrically isolating the second battery and the vehicle brake means from the first battery and the at least one vehicle electric load, and automatically assuming the engaged position of the vehicle brake means.

According to another aspect of the invention there is provided a vehicle comprising any of the electrical systems described above, or configured to perform the method described above.

According to yet another aspect of the invention there is provided a non-transitory, computer-readable storage medium storing instructions thereon that when executed by one or more processors causes the one or more processors to carry out the method described above.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 shows a schematic plan view of a vehicle having an electrical system of electrical components of the vehicle according to an embodiment of the invention, in which both electronic switches of the electrical system are closed;

FIG. 2 shows the electrical system of FIG. 1, and in which a short circuit has occurred across a battery terminal of the electrical system;

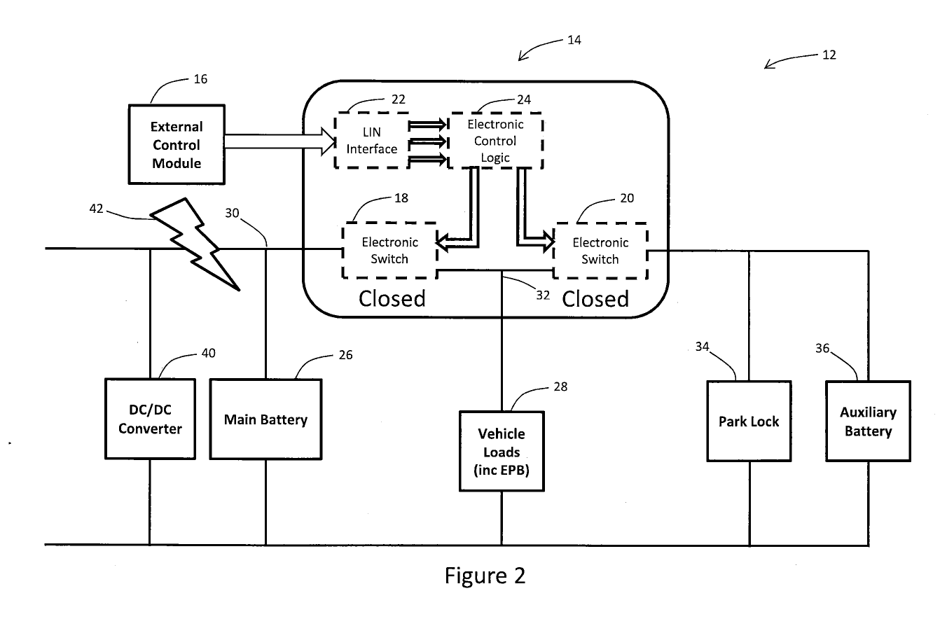

FIG. 3 shows the electrical system of FIG. 2, additionally showing possible locations at which a fuse may blow in the electrical system in dependence on the location of the short circuit, and in which one of the electronic switches is open;

FIG. 4 shows the electrical system of FIG. 3, additionally indicating a section of the electrical system which has become electrically isolated from the remainder of the electrical system because of one of the electronic switches being open; and,

FIG. 5 shows the control steps of a method undertaken by the electrical system of FIG. 1;

### DETAILED DESCRIPTION

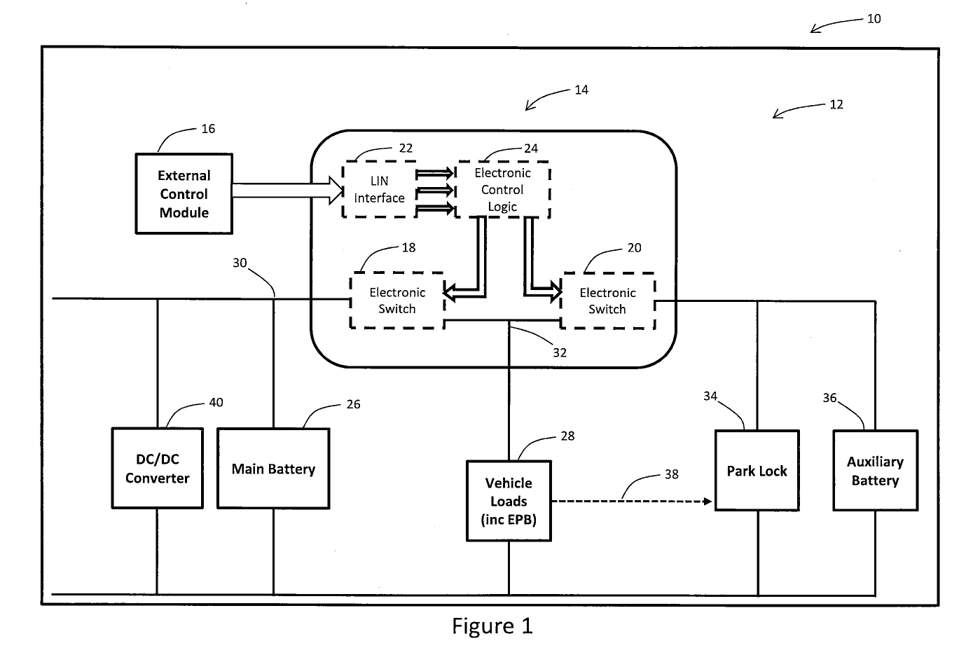

FIG. 1 shows a schematic overview of an electrical system 12 of a vehicle 10. The vehicle 10 is an electric vehicle. The electrical system 12 includes a power supply distribution board (PSDB) 14 having an external control module (ECM) or controller 16 operable to control a first electronic switch 18 and a second electronic switch 20 to assume either a closed position (to complete an electronic circuit) or an open position (to break an electronic circuit). The switches 18, 20 are high-capacity field-effect transistors (FETs). The ECM 16 controls the switches 18, 20 via a local interconnect network (LIN) interface 22 and an electronic control logic module 24 of the type known in the art.

The electrical system 12 includes a main (first) vehicle battery 26. The electric vehicle 10 has a separate high-voltage electric vehicle battery (not shown) for providing motive power to the vehicle; however, the main vehicle battery 26 is a standard automotive lead-acid battery, also referred to as a starting, lighting and ignition (SLI) battery, that provides nominally 12 volts of direct current for providing power to one or more vehicle loads 28, as discussed below. The main vehicle battery 26 has a capacity of about 40 ampere hours of electric charge. Other values may also be useful.

The electrical system 12 also includes the one or more vehicle loads 28. The vehicle loads 28 include all of the electronic control units (ECUs) for controlling the electrical systems or components in the vehicle 10 that are powered by the main vehicle battery 26. The ECUs may include one or more of an engine management system, electric power steering control unit, battery management system, speed control unit, powertrain control module, etc. The electrical systems or components may include, for example, exterior lights of the vehicle, windscreen wipers, power steering assist, power windows, etc.

The vehicle loads 28 include a control module or control means for commanding actuation of an electric park brake (EPB) of the type described above. In the present embodiment, the EPB is activated by the driver selecting a park mode of the vehicle transmission. In particular, the EPB control module selectively controls electric motors powered by the main vehicle battery 26 to apply brake pads to the brakes of the rear wheels of the vehicle so as to hold the vehicle stationary. The EPB control module commands the electric motors to release the brake pads from the rear wheel brakes upon further actuation of the push button by the driver. The EPB control module may also command the electric motors to release the brake pads upon the driver depressing an accelerator pedal of the vehicle 10, or in line with a hill start assist feature to guard against vehicle rollback when moving off from rest on a hill.

In the electrical system 12, a terminal 30 of the main vehicle battery 26 is connected to a terminal 32 of the vehicle loads 28 via the first electronic switch 18. When the first switch 18 is closed, the main vehicle battery 26 provides power to operate the vehicle loads 28.

FIG. 1 shows that, separate in the electrical system 12 from the vehicle loads 28, the electrical system 12 includes an electrically operable transmission park lock or actuator 34 of the vehicle 10. The transmission park lock includes engaging means in the form of a transmission pawl or pin which can engage a notched wheel located on the output shaft of the vehicle transmission. The notched wheel includes a series of notches around the outer circumference of the wheel, and so around the outer circumference of the wheel.

In an engaged position the pawl or pin engages one of the notches of the notched wheel. This acts to inhibit rotational motion of the transmission output shaft. In the present embodiment, it is the drive of a rear axle of the vehicle 10 that is locked. As rotation of the transmission output shaft drives rotation of the drive wheels of the vehicle, inhibiting rotational motion of the transmission output shaft inhibits movement of the vehicle, i.e. it keeps the vehicle stationary. In contrast, in a disengaged position the pawl does not interfere with or inhibit rotation of the transmission output shaft, and so does not prevent rotation of the vehicle driven wheels. Furthermore, the notches are arranged such that, when the output shaft is rotating at a speed above a certain value and the park lock is moved from the disengaged position to the engaged position, the pawl ratchets between the notches of the notched wheel. This ratcheting causes the output shaft speed, and hence the vehicle speed, to decrease.

The pawl and notched wheel are arranged so that once the output shaft speed decreases below a threshold value, caused by the ratcheting motion, the pawl comes into locked engagement with one of the notches, thus holding the output shaft (and the vehicle) stationary. The threshold output shaft speed is small enough that locking the pawl into engagement will not cause damage to the park lock: damage may occur if the force applied by the notched wheel to the pawl caused by the rotational motion of the output shaft is sufficiently large. The threshold output shaft speed corresponds to a threshold vehicle speed, which may be any suitable speed, but may be around 5 kilometres per hour.

The electrical system 12 also includes an auxiliary (second) vehicle battery 36. Like the main vehicle battery 26, the auxiliary battery 36 provides nominally 12 volts of direct current. In the present embodiment, the auxiliary battery 36 has a lower capacity than the main battery 26, the auxiliary battery 36 having about 14 ampere hours of electric charge. Other values may also be useful.

The vehicle loads 28 include a park lock control module or control means for controlling the transmission park lock actuator 34 to move between the engaged and disengaged positions. This command or control signal is indicated by arrow 38 in FIG. 1. In particular, the park lock control module commands one or more electric motors powered by the auxiliary battery 36 to move the transmission pawl into or out of engagement with the notched wheel. For example, the park lock control means may command the park lock to assume the engaged position upon the driver depressing the EPB push button to engage the EPB. The EPB and park lock control modules may in fact be a single module. The auxiliary battery 36 provides power to the park lock actuator 34 irrespective of whether the switches 18, 20 are open or closed. That is, the auxiliary battery 36 provides a permanent power supply to the park lock actuator 34.

FIG. 1 shows that the main battery 26 and the auxiliary battery 36 are arranged in parallel. FIG. 1 further shows that the electrical system 12 includes a dc/dc converter 40 connected to both of the batteries 26, 36 when the switches 18, 20 are closed. In the present embodiment, the main and auxiliary batteries 26, 36 have the same voltage, and so the entire electrical system 12 shown in FIG. 1 can be considered to be a single circuit. Hence, when both of the switches 18, 20 are closed, both of the batteries 26, 36 provide power to both the vehicle loads 28 and the park lock actuator 34.

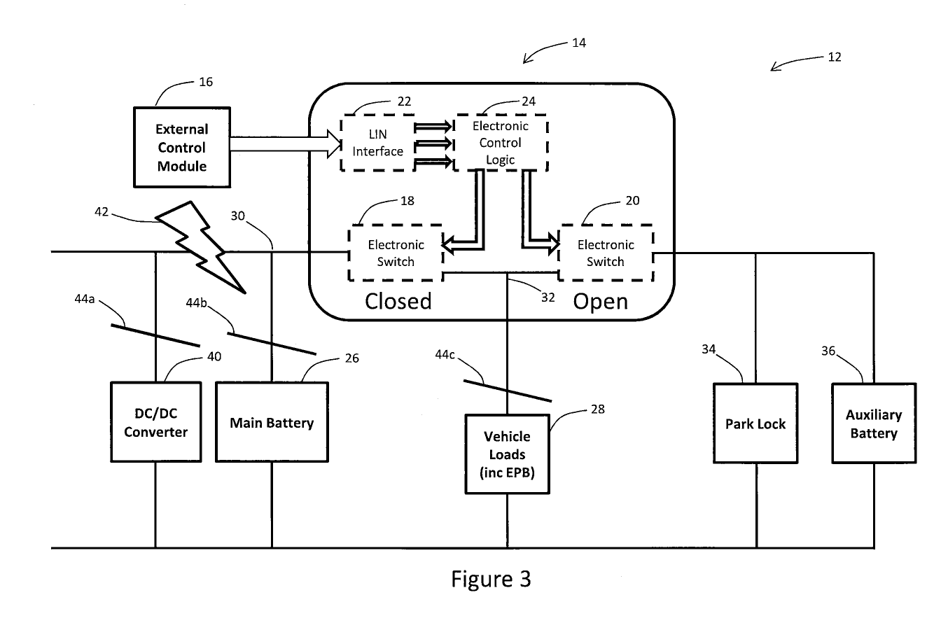

With reference to FIG. 3, in normal operation of the electrical system 12 both of the switches 18, 20 are closed. In the event of a short circuit in the electrical system 12, for example as indicated by the short 42, the electrical circuit would be broken and the batteries 26, 36 would not be able to provide power to the vehicle loads 28, i.e. power is lost to the loads terminal 32. In particular, this means that the park lock control module of the vehicle loads 28 would not be operable to control the park lock actuator 34, i.e. arrow 38 in FIG. 1. In such a case, power would be lost across the entire system 12 and none of the vehicle electrical systems could operate, that is, neither the EPB nor the transmission park lock could be activated to keep the vehicle stationary in such a case.

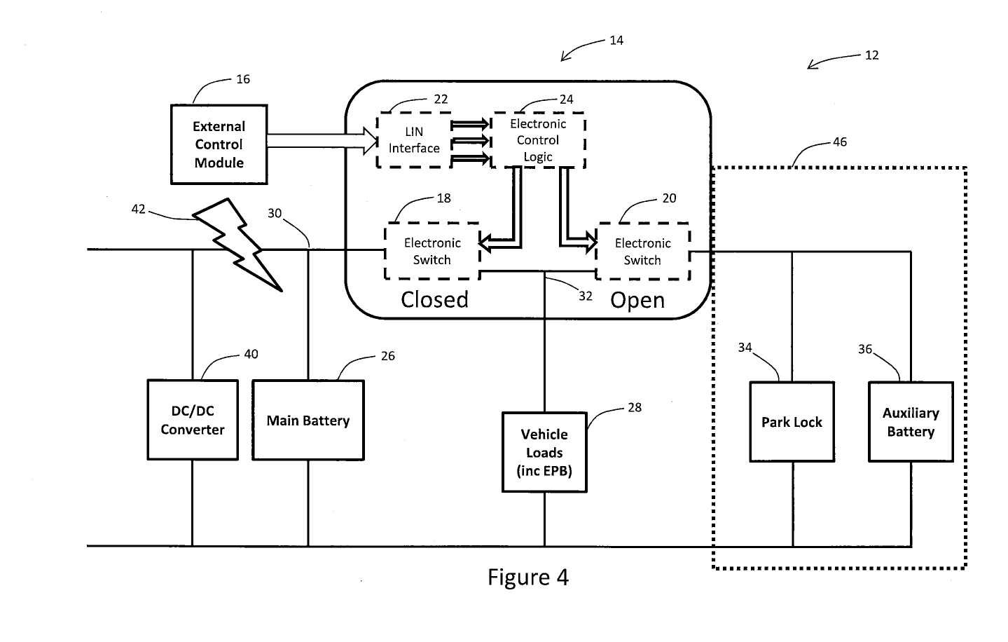

FIG. 3 shows possible locations 44a, 44b, 44c in which a fuse may blow in the event of a short circuit 42. Any combination of these fuses 44a, 44b, 44c may blow depending on the exact location of the short 42, among other factors. In response to such a short circuit 42 and/or any combination of the fuses 44a, 44b, 44c blowing across the electrical system 12, the ECM 16 is operable to control to the second switch 20 to open. This electrically isolates the park lock 34 and the auxiliary battery 36 from the remainder of the electrical system 12, in particular as shown by the schematic isolation box 46 in FIG. 4. This means that, although the voltage across the loads terminal 32 will be insufficient to power the vehicle loads 28, the voltage across a terminal 48 of the auxiliary battery 36 will remain sufficient, e.g. nominally 12 volts, to power the park lock actuator 34. However, as mentioned above, the park lock control module for commanding actuation of the park lock 34 is part of the vehicle loads 28 and so, as there is a loss of power to the vehicle loads 28, the park lock control module is not able to send a control signal to actuate the park lock 34. Therefore, in the present embodiment, when the ECU 16 commands the second switch 20 to open, the park lock actuator 34 is operable to automatically assume the engaged position.

That is, when power from the main battery 26 to the park lock actuator 34 is lost, the park lock actuator 34 is operable under power of the auxiliary battery 36 to automatically move the transmission pawl into engagement with the notched wheel.

FIGS. 3 and 4 show the switch 18 being controlled to open in the event of a short circuit or a fuse blowing; however, more generally, the switch 18 is controlled to open when a fault is detected in the electrical system 12. For example, the fault may be that the main battery 26 has been removed or disconnected from the system 12, or that the charge of the main battery 26 has reduced to zero, i.e. the battery 26 is dead. The fault may be a loss of power is detected in at least one of the vehicle electric loads 28.

The system 12 determines that there is a fault by monitoring the level of voltage in the system 12. In particular, if a measured value of the voltage in the system 12 falls below a threshold value for a predetermined period of time, then it is determined that a fault has occurred. In the present embodiment, the threshold voltage value is 8 volts, and predetermined period of time is one millisecond.

In the same way in which it detects the fault, when the electrical system 12 verifies that the fault has been removed, the ECM 16 controls the second switch 20 to close so as to return the electrical system 12 to its ‘normal’ configuration as shown in FIG. 1. That is, the park lock actuator 34 returns to being powered by both the main and auxiliary batteries 26, 36. However, the park lock actuator 34 does not automatically move to the disengaged position upon returning to being powered by both of the batteries 26, 36. Instead, the park lock 34 remains in the engaged position to inhibit movement of the vehicle 10 until the control signal 38 is sent from the park lock control module to disengage the park lock 34. Alternatively, the park lock actuator 34 may be disengaged manually by pulling a mechanical emergency park release cable connected to the actuator 34. For example, the emergency park release cable may be located under a bonnet of the vehicle 10.

The park lock actuator 34 is bistable. That is, the park lock 34 is stable in both the engaged and disengaged positions of the pawl and notched wheel. This means that the park lock actuator 34 will remain in its previously commanded position, i.e. the park lock will not automatically return to the disengaged position upon being controlled to assume the engaged position, or vice versa. This is advantageous in that it leads to a system having lower power consumption: an electric vehicle having reduced power requirements increases the potential range of the vehicle, i.e. the vehicle can travel a greater distance before recharging is needed. For example, if the park lock actuator 34 was monostable, then upon the switch 20 being opened, a continuous command (and therefore continuous power) would need to be sent to first move, and then maintain, the park lock 34 to the engaged position. As the park lock actuator 34 is bistable, the auxiliary battery 36 simply needs to power the actuator 34 to the engaged position upon the switch 20 opening, and the actuator 34 will remain in that position until commanded otherwise. Note that the EPB is also bistable in the present embodiment.

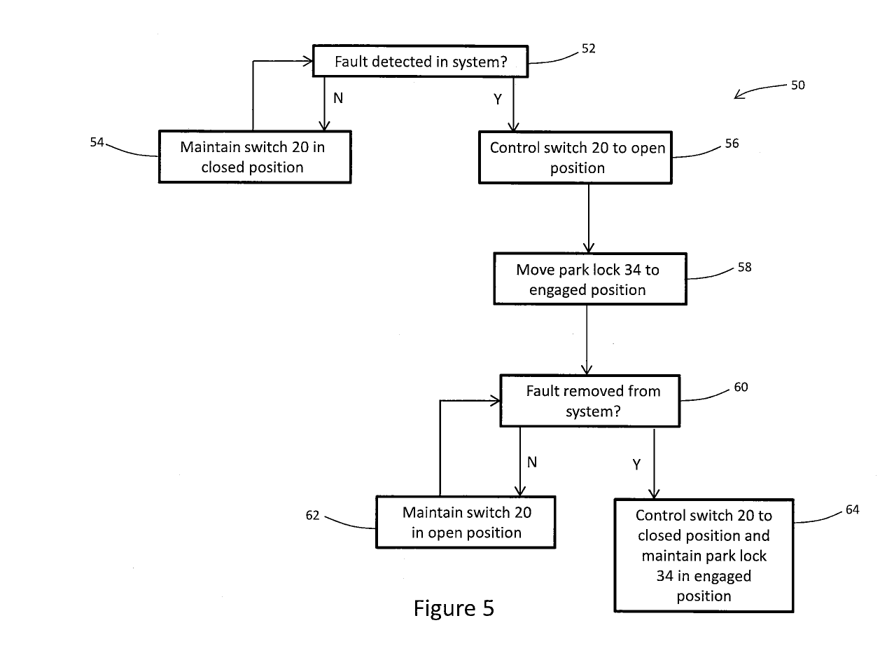

The control steps of the method 50 described above as undertaken by the electrical system 12 are summarised in the flow diagram of FIG. 5. At step 52, the system 12 detects whether there is an electrical fault in the circuit as described above, e.g. drop in voltage across the circuit. If no fault is detected, then at step 54 no action is taken with the second switch 20 being maintained in the closed position so that both the main and auxiliary batteries supply power to the park lock actuator 34. If a fault is detected, then at step 56 the ECM 16 sends a control signal to open the second switch 20 so as to electrically isolate the park lock 34 from the main battery 26 and the main vehicle loads 28. That is, the main battery 26 does not supply power to the park lock actuator 34. Once the second switch 20 has been opened, the park lock actuator 34 is configured to automatically move the park lock from the disengaged position to the engaged position under power from the auxiliary battery 36. The system 12 checks at step 60 whether the electrical fault has been removed, e.g. the voltage returning to ‘normal’ levels. While there remains a fault in the system 12, the second switch 20 is maintained in the open position at step 62. When the system 12 detects that the fault has been removed, the ECU 16 sends a control signal to close the second switch 20 so as to electrically connect the main battery 26 and the vehicle loads 28 to the park lock actuator 34. The park lock is, however, maintained in the engaged position until a further command is received for it to disengage. This may be via the signal 38 from the park lock control module, which is part of the vehicle loads 28.

Many modifications may be made to the above examples without departing from the scope of the present invention as defined in the accompanying claims.

1. An electrical system for use in a vehicle, the electrical system comprising:
a controller;
an electrically operable vehicle brake;
at least one vehicle electric load including an electronic processor operable to selectively control the vehicle brake to move between an engaged position in which the vehicle brake inhibits movement of the vehicle and a disengaged position in which the vehicle brake does not inhibit movement of the vehicle; and,
first and second batteries for providing electric power to the vehicle brake and the at least one vehicle electric load,
wherein, in response to detection of a fault in the electrical system, the controller is operable to electrically isolate the second battery and the vehicle brake from the first battery and the at least one vehicle electric load, and the vehicle brake is configured to automatically assume the engaged position.

2. The electrical system according to claim 1, further comprising an electronic switch, wherein the electrical system is operable to change the electronic switch from a closed position to an open position to electrically isolate the second battery and the vehicle brake from the first battery and the at least one vehicle electric load.

3. The electrical system according to claim 1, the fault being detected with reference to a change in a measured value of a voltage across the electrical system.

4. The electrical system according to claim 3, wherein the fault is detected if the change in the measured value of the voltage results in the measured value falling below a predetermined measured voltage value.

5. The electrical system according to claim 4, wherein the fault is detected if the measured value falls below the predetermined measured voltage value for at least a predetermined period of time.

6. The electrical system according to claim 1, wherein the fault is detected if the first battery is removed from the electrical system and/or if the first battery has substantially zero electric charge and/or if a short is detected in the electrical system and/or if a loss of power is detected in at least one of the at least one vehicle electric loads.

7. The electrical system according to claim 1, wherein, in response to detection that the fault in the electrical system has been removed, the controller is operable to electrically connect the second battery and the vehicle brake to the first battery and the at least one vehicle electric load, and the vehicle brake is configured to remain in the engaged position.

8. The electrical system according to claim 1, wherein the vehicle brake is bistable in the engaged and disengaged positions.

9. The electrical system according to claim 1, wherein the first battery is connected in parallel with the second battery.

10. The electrical system according to claim 1, wherein the first battery has a greater capacity than the second battery.

11. The electrical system according to claim 1, wherein the vehicle brake is configured to engage with an output shaft of a transmission of the vehicle when the vehicle brake is in the engaged position so as to inhibit rotation of the output shaft.

12. The electrical system according to claim 11, wherein the vehicle brake comprises a transmission pawl configured to engage a notched wheel of the output shaft when the vehicle brake is in the engaged position.

13. The electrical system according to claim 12, wherein the transmission pawl is configured to ratchet the notched wheel when the vehicle brake is in the engaged position and a speed of the vehicle is greater than a speed threshold value.

14. The electrical system according to claim 13, wherein the transmission pawl is configured to come into locked engagement with the notched wheel when the vehicle brake is in the engaged position and the speed of the vehicle is less than the speed threshold value.

15. The electrical system according to claim 1, wherein the at least one vehicle electric load comprises a second electrically operable vehicle brake, wherein the electronic processor is operable to selectively control the second vehicle brake to move between an engaged position in which the second vehicle brake inhibits movement of the vehicle and a disengaged position in which the second vehicle brake does not inhibit movement of the vehicle.

16. The electrical system according to claim 15, wherein the second brake is an electric parking brake.

17. The electrical system according to claim 15, wherein the electronic processor is configured to command the vehicle brake and the second further vehicle brake to assume their respective engaged positions when a park mode of the transmission is selected by the driver.

18. A method for use in a vehicle electrical system, the electrical system comprising a controller, an electrically operable vehicle brake, at least one vehicle electric load including an electronic processor operable to selectively control the vehicle brake to move between an engaged position in which the vehicle brake inhibits movement of the vehicle and a disengaged position in which the vehicle brake does not inhibit movement of the vehicle, and first and second batteries for providing electric power to the vehicle brake and the at least one vehicle electric load,
the method comprising:
detecting a fault in the electrical system, and in response thereto, electrically isolating the second battery and the vehicle brake from the first battery and the at least one vehicle electric load, and automatically assuming the engaged position of the vehicle brake.

19. A vehicle comprising the electrical system of claim 1.

20. A non-transitory, computer-readable storage medium storing instructions thereon that when executed by one or more processors causes the one or more processors to carry out the method of claim 18.
